(19) United States
(12) Patent Application Publication
(10) Pub. No.: US 2009/0113511 A1
(43) Pub. Date: Apr. 30, 2009

(54) DISTORTION AND NOISE CANCELING SYSTEM FOR HFC NETWORKS

(75) Inventor: Ki Chang Lee, Seoul (KR)

Correspondence Address: LARSON AND LARSON, 11199 69TH STREET NORTH, LARGO, FL, 33773, US

(73) Assignee: HOSEO UNIVERSITY ACADEMIC COOPERATION FOUNDATION, Chungcheongnam-do (KR)

(21) Appl. No.: 11/957,310

(22) Filed: Dec. 14, 2007

(30) Foreign Application Priority Data
Oct. 25, 2007 (KR) 10-2007-0107716

(51) Int. Cl. H04N 7/173

(52) U.S. Cl. 725/129

(57) ABSTRACT

Canceling and removing distortion and noise components of a signal generated in a hybrid fiber-coax (HFC) network. The system transmits an optical signal from an input side of an optical network unit of an existing HFC network to a coaxial distribution hub through a separate optical fiber jumper; converts the optical signal into a reference RF signal; extracts only the distortion and noise component by combining the reference RF signal with the degraded main RF signal, in opposite phase, containing distortions and noises generated, while the main RF signal passes through coaxial cables and cascaded coaxial amplifiers in coaxial paths of an HFC network; canceling out the distortion and noise component by combining the extracted distortion and noise component with the degraded main RF signal, in opposite phase.

### BACKGROUND OF THE INVENTION

1. Field of the Invention

The present invention relates to a distortion and noise canceling system for hybrid fiber-coax (HFC) networks, which cancels the distortion and noise components occurred and accumulated in the coaxial paths of an HFC network and improves the signal quality and transmission performance of an HFC network.

More specifically, the invented system enhances the transmission characteristics of an HFC network and thus improves the qualities of the signal by canceling distortion and noise mainly generated and accumulated in the coaxial paths of an HFC network. HFC network is an optical fibers and coaxial cables combined architecture to transmit broadband broadcasting and/or communication signals from a head-end to subscribers, wherein the signals are transmitted in optical domain from a head-end to optical network units (ONU) by the use of low-loss optical fibers, and ONU converts the optical signal to radio frequency (RF) signal, and the RF signals are transmitted in RF domain from ONUs to subscribers by the use of lossy coaxial cables. Since the coaxial paths have big attenuation, coaxial trunk amplifiers are used in cascade to compensate the signal loss, and wherein distortion and noise are generated and accumulated due to the non-linearity and noise figure of the amplifiers. This results in performance degradation of HFC networks and limits the transmission capacity of HFC network and transmission distance as well. The invented system cancels the distortions and noise out at coaxial distribution hubs, and remedies the fateful drawback of HFC network.

2. Description of the Prior Art

An HFC network is a communication network that is configured by efficiently combining optical fibers and coaxial cables and is widely used to transmit and distribute multi-channel cable television broadcast signals. An HFC network has many benefits such as wide bandwidth, reliability, expandability, cost-effectiveness, as well as ease of workmanship, etc. Furthermore, an HFC network can provide a bi-directional (upstream and downstream) communication at moderate price by the use of single coaxial line, and also can supply AC power current for amplifiers by overlapping it with RF signal over a coaxial cable. These are why HFC networks are most widely used today for broadband application such as cable TV transmission and distribution networks.

In a cable television broadcasting station, multi-channel cable television signals are collected together in a head-end and transmitted to a distribution center through an optical fiber. The distribution center splits the received optical signals into multiple strands of optical fibers and transmits the split optical signals to several ONUs.

The distance from a head-end to ONUs is comparatively long to the extent of some kilometers or some tens of kilometers. However, since broadband multi-channel cable television signals are transmitted through single-mode optical fibers, the path loss, distortions and noises are considerably low.

Then, the ONU converts the optical signals into RF signals. The converted RF signals are transmitted to coaxial distribution hubs through several coaxial cables and the same numbers of coaxial trunk amplifiers, and each coaxial distribution hub then transmits the RF signals to subscriber's terminals through coaxial cables, distribution or extension amplifiers, RF splitters and a tap-off.

Although the distance from an ONU to a coaxial distribution hub is comparatively as short as some hundred meters to some kilometers, the signal path loss is very high because the broadband RF signals are transmitted through lossy coaxial cables. Accordingly, several coaxial trunk amplifier stages are connected in cascade at certain intervals to compensate the coaxial path loss. In these coaxial cascade amplifiers, considerable amount of distortions and noises are generated and accumulated due to the non-linearity and noise figure characteristics of the amplifiers.

In accordance with the recent trend of integrating broadcast and communication, HFC networks are not only used for the transmission of cable television, but also for internet communication, voice over internet protocol (VoIP), video on demand (VOD), tele-metering and the like, expanding its applications and additional services continuously. Particularly, as per the requests from the modern media industries, the number of transmission channels and additional services of an HFC network are further increasing day by day.

Also, in accordance with modern technological trends, such as digitalization of broadcasting, convergence of communication and broadcast, and multi-channel/diversified-media tendency, more expanded transmission bandwidth and more improved transmission performances are required. Therefore, the performance enhancement of HFC network is a prerequisite issue to play its important role as a backbone infrastructure of communication and broadcast in modern society.

### SUMMARY OF THE INVENTION

The HFC network, however, has also several disadvantages and limitations. While the optical path of an HFC network has very wide bandwidth with flat frequency response and very low path loss enabling long haul transmission of signals, the coaxial path of an HFC network is characterized by non-flat frequency response and very high path loss limiting to short haul transmission of signals. Actually, the transmission path loss of a coaxial cable is high as much as some tens to hundreds times that of an optical fiber as per the frequency, increasing logarithmically proportional to the square root of frequency.

Therefore, an HFC network is equipped with a number of coaxial trunk amplifiers connected in cascade in order to compensate the coaxial cable loss at about every 200 to 400 meters interval, which is a distance where the signal attenuation reaches about 20 dB. The distance between the coaxial trunk amplifiers varies depending on the transmission loss of a coaxial cable being used, the number of channels to be transmitted, and transmission bandwidth.

In addition, the number of amplifier stages connectable in cascade could be 5 to 20 stages depending on the transmission performance and the required signal quality, as much as the accumulated distortion and noise level in a final amplifier satisfies the required signal specification. That is, the most essential performances of an HFC network are, therefore, inter-modulation distortion (IMD), cross modulation (X-MOD) and carrier-to-noise ratio (CNR), and coaxial trunk amplifiers dominate those factors.

Practically, a cable television system transmits more than 60 to almost 200 analog and digital television channels by means of frequency division multiplexing (FDM). Therefore, the downstream signal in an HFC network contains hundreds of carrier components including video carriers, audio carriers and color sub-carriers of analog television signal, digital television carriers, internet data carriers and a variety of carrier components for additional services of cable television.

If any non-linearity exists in coaxial amplifier transfer function, hundreds of carriers are non-linearly amplified, and the non-linear amplification results in amplitude modulations between arbitrary combinations of carriers. Therefore, in an HFC cable television system, thousands of sum and difference frequency components (beat product) are generated, and these components are definitely distortions which did not exist in the original signal, and interfere with the signal components.

The most critical performance factors among the IMD of an HFC network are composite second order (CSO), a 2^{nd} order distortion, composite triple beat (CTB), a 3^{rd} order distortion, and carrier-to-noise ratio (CNR), a relative noise amount. The objective of the present invention is to provide a distortion and noise canceling system for an HFC network, and to enhance these CSO, CTB and CNR performances of an HFC network, and consequently to improve the signal quality delivered to subscriber terminals.

Actually, the distortion and noise canceling system for an HFC network of the present invention supplements an optical coupler, optical splitter and additional optical fiber jumpers from an ONU input terminal to required coaxial distribution hubs onto a conventional HFC network. The optical coupler and splitter picks up certain amount of undegraded (not containing distortions and noise) optical signal, and splits it into required number of optical jumpers, and transmits the optical signals to each coaxial distribution hub.

The coaxial distribution hub is provided with a distortion and noise canceling unit together with a traditional two-way coaxial amplifier. The distortion and noise canceling unit converts the received optical signal into an undegraded RF signal and extracts difference component signal which is, in fact, distortion and noise component by comparing the undegraded RF signal with the main RF signal received through the coaxial cables and cascaded coaxial trunk amplifiers.

The extracted distortion and noise component is then combined again in reverse (opposite) phase with the degraded RF signal received through the coaxial path including coaxial cables and cascaded coaxial trunk amplifiers. Accordingly, the distortion and noise component contained in the degraded RF signal received through the coaxial path is canceled out, and thus, the coaxial distribution hub outputs distortion-and-noise-free RF signals to subsequent distribution networks and subscriber terminals that follow.

Therefore, the distortions and noises canceling system for an HFC network of the present invention, comprises an ONU for converting an optical signal received from a head-end side through a first optical fiber into a RF signal, and transmitting the converted RF signal to a coaxial distribution hub through a coaxial cable; a number of coaxial trunk amplifiers connected to the coaxial cable in cascade to amplify the RF signal; an optical tap-off (optical coupler) for tapping an optical signal from the first optical fiber at the optical input terminal of the ONU, and transmitting the tapped optical signal to the coaxial distribution hub through a second optical fiber; and a distortion and noise canceling unit installed in the coaxial distribution hub, extracting a distortion and noise component contained in the degraded RF signal received through the coaxial cable and cascaded amplifiers using the undegraded optical signal transmitted through the second optical fiber, and canceling the distortion and noise component by combining the extracted distortion and noise component with the degraded RF signal received through the coaxial cable and cascaded amplifiers in 180° opposite phase.

The distortion and noise canceling unit may comprise a distortion and noise component extraction circuit for converting the optical signal received through the second optical fiber into an RF signal and extracting the distortion and noise component by combining the converted undegraded RF signal with the degraded RF signal received through the coaxial path, in opposite phase, and a canceling circuit for removing the distortion and noise component by combining the distortion and noise component extracted by the distortion and noise component extraction circuit with the degraded RF signal received through the coaxial path, in opposite phase.

In addition, the distortion and noise canceling unit may comprise a directional coupler for splitting the degraded RF signal received through the coaxial path and respectively inputting the split RF signals into the distortion and noise component extraction circuit and the canceling circuit.

The distortion and noise component extraction circuit may comprise an optical/RF signal converter for converting the optical signal received through the second optical fiber into the RF signal; a delay line device for delaying the RF signal converted by the optical/RF signal converter; and a directional coupler for extracting the distortion and noise component by subtracting the undegraded RF signal delayed by the delay line from the degraded RF signal received through the coaxial path.

The distortion and noise component extraction circuit may further comprise an equalizer, located either after the optical/RF signal converter or after the delay line, for adjusting the total frequency response characteristic of the undegraded RF signal converted by the optical/RF signal converter to have the identical frequency response with the degraded RF signal coming through the coaxial path.

The distortion and noise component extraction circuit may further comprise an attenuator for adjusting the degraded RF signal level to the same level as the undegraded RF signal level.

The canceling circuit may comprise a directional coupler for subtracting the distortion and noise component extracted by the distortion and noise component extraction circuit from the degraded RF signal received through the coaxial path.

The canceling circuit may further comprise an error amplifier for amplifying the distortion and noise component extracted by the distortion and noise component extraction circuit and inputting the amplified distortion and noise component to the directional coupler; and a phase shifter for adjusting the phase of degraded RF signal received through the coaxial path to have the same phase with the error amplifier output waveform and inputting the shifted RF signal to the directional coupler.

### BRIEF DESCRIPTION OF THE DRAWINGS

Hereinafter, the present invention will be described in detail based on a preferred embodiment not limiting the present invention with reference to the accompanying drawings. In some drawings, like reference numerals are used to designate like elements.

FIG. 1 is a schematic diagram showing the overall configuration of an HFC network including a distortion and noise canceling system of the present invention;

FIG. 2 is a schematic diagram showing a preferred embodiment of the distortion and noise canceling system of the present invention;

FIG. 3 is a schematic diagram explaining the operational principle of the distortion and noise canceling system of the present invention; and

FIG. 4 is a detailed schematic diagram showing an embodiment in which the distortion and noise canceling system of the present invention is applied to a conventional bridge amplifier of a coaxial distribution hub in an HFC network.

### DETAILED DESCRIPTION OF THE PREFERRED EMBODIMENT

The following details are only for illustrative purposes and illustrate merely an example of embodiments of the present invention. In addition, the principle and concept of the present invention are most useful and provided for the purpose of being easily explained.

Thus, over-detailed configurations for the fundamental understanding of the present invention are not intended to be provided, but a variety of forms implemented by those skilled in the art within the scope of the present invention will be illustrated through the drawings.

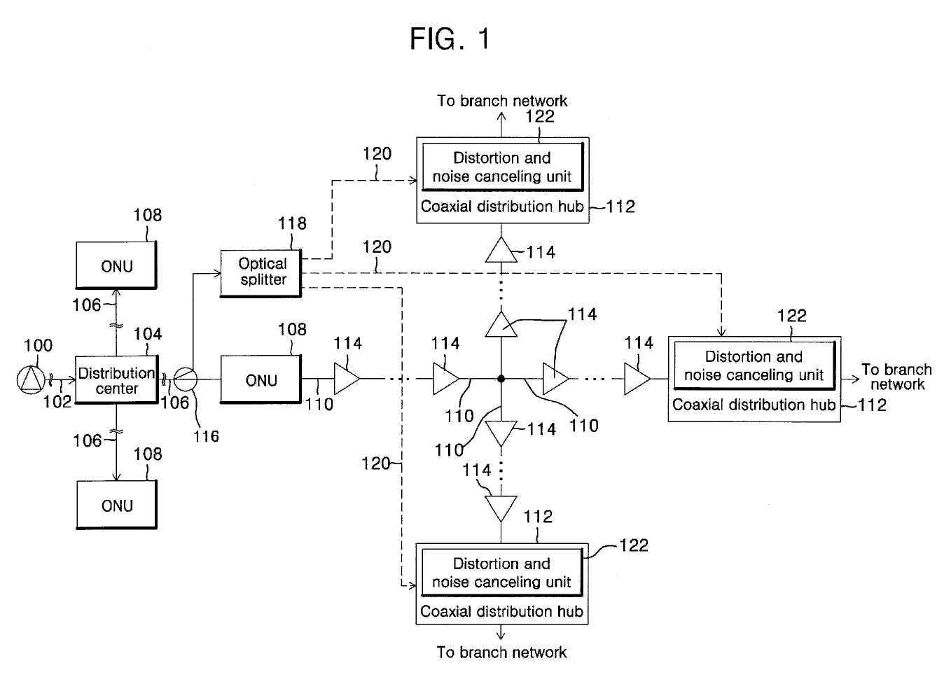

FIG. 1 is a schematic diagram showing the overall configuration of an HFC network including a distortion and noise canceling system of the present invention. In the HFC network, a head-end 100, which is a full set of equipments for transmitting cable television broadcast signals, outputs a frequency-division-multiplexed (FDM) multi-channel optical signal. The optical signal output from the head-end 100 is transmitted to a distribution center 104 which is an optical node, via an optical fiber 102. The distribution center 104 distributes the optical signal into several strands of optical fibers. The plural optical signals from the distribution center 104 are transmitted to plural ONUs 108 installed in distribution nodes of several areas via plural optical fibers 106, respectively.

Although the distance from the head-end 100 to the ONU 108 is as comparatively long as some kilometers to some tens of kilometers, the link loss as well as the amount of distortion and noise of the optical path is considerably low because the signal is transmitted via the low-loss single mode optical fibers 102 and 106.

Each ONU 108 converts the received optical signal into a radio frequency (RF) signal and transmits the converted RF signal to plural coaxial distribution hubs 112 through coaxial cables 110 and cascaded coaxial trunk amplifiers 114.

When transmitting through the coaxial cable 110, the RF signal is attenuated rapidly because the coaxial path loss is several tens to several hundreds times the optical path loss.

Therefore, a coaxial trunk amplifier 114 has to follows right after the loss of coaxial cable 110 reaches approximately 20 dB to amplify the RF signal and compensate the path loss of about 20 dB. And, then transmitted through coaxial cable 110 again and amplified again by coaxial trunk amplifier 114 again, and so on. This architecture results in a cascaded coaxial trunk amplifiers 114 are connected every 200 to 400 meters in between the coaxial cables 110.

In this manner, the RF signal is transmitted up to the coaxial distribution hub 112 and, the coaxial distribution hub 112 transmits the RF signal to subscriber terminals using bridge amplifiers and/or an extender amplifier (not shown). In such an HFC network, the RF signal is amplified using the plural coaxial trunk amplifiers 114 in order to compensate the attenuation of RF signal generated in the process of transmitting the RF signal output from the ONU 108 to the coaxial distribution hub 112 through the coaxial cable 110. During the amplifications by the plural coaxial trunk amplifiers 114, considerable distortions and noises are generated and accumulated whenever the RF signal passes through each of the coaxial trunk amplifiers 114, and therefore, the RF signal is degraded more and more.

Therefore, in the present invention, an optical tap-off (or an optical coupler) 116 is provided at the strand end of the optical fiber 106 transmitting the optical signal from the distribution center 104 to the ONU 108, and a portion of the optical signal is tapped. The optical signal tapped by the optical tap-off 116 is split into several strands of optical fibers 120 by an optical splitter 118, and is transmitted to the plural coaxial distribution hubs 112 converting optical signal into RF signal and processing it, through optical fibers 120, almost without signal loss and degradation in terms of distortion and noise because the optical fiber 120 jumper distance for the coaxial path is very short compared to the optical path and optical fiber attenuation is low enough.

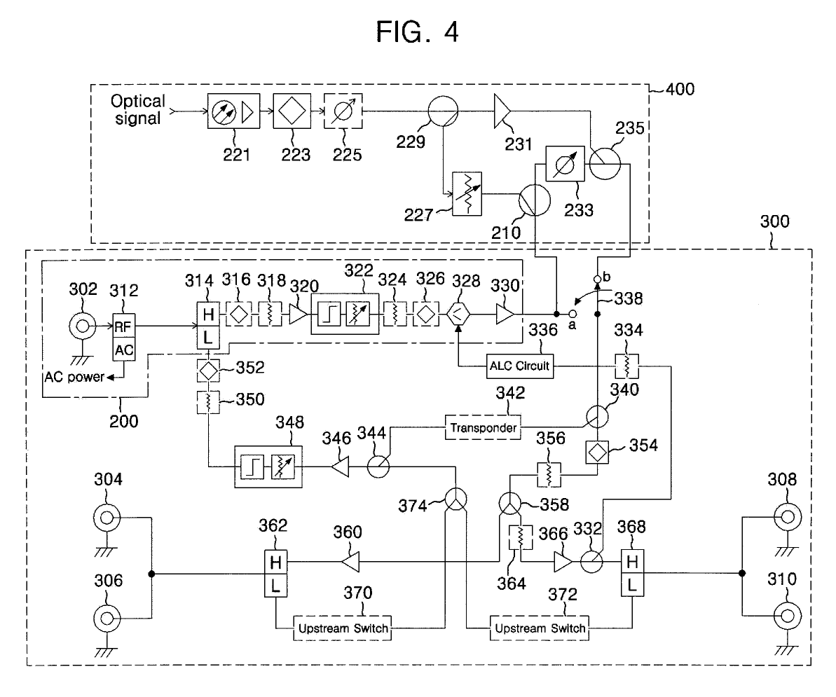

One important thing which we have to realize here is that we can not use the optical signal output from the optical fiber 120 after RF conversion as a main downstream RF signal for the HFC network, even though the optical signal output is almost no loss, no distortion and no noise. There are two reasons. First reason is that the optical signal output level from the optical fiber 120 is essentially very low because it was tapped at minor share in optical tap-off 116 and is not enough to drive the coaxial distribution hub 112 for following branch networks. To drive the coaxial distribution hub 112, it should be amplified at high gain after RF conversion. But, during high gain amplification it will be degraded with distortions and noises. Second reason is that every coaxial amplifier in the coaxial paths are configured with bi-directional operation (forward/reverse or downstream/upstream two-way amplification as shown in FIG. 4). For this reason, when using the optical fiber 120 as a main signal downstream path, the reverse (upstream) signal path can not be arranged and thus bi-directional link will not work.

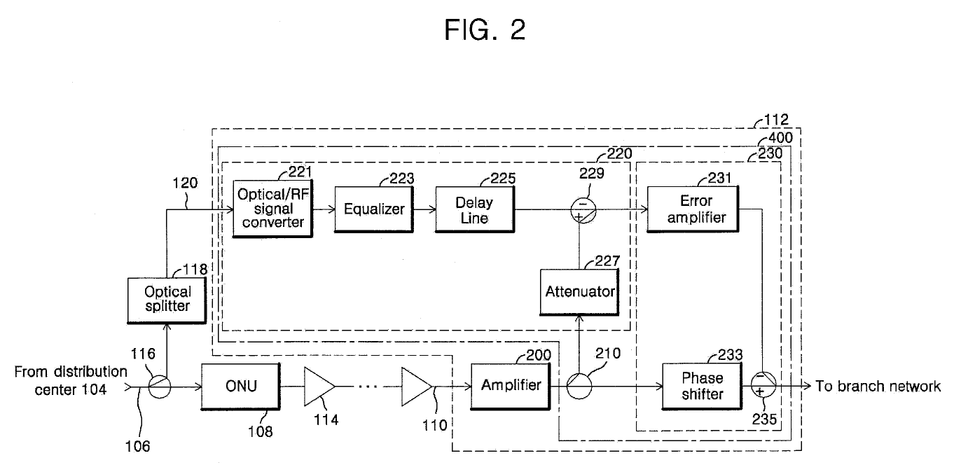

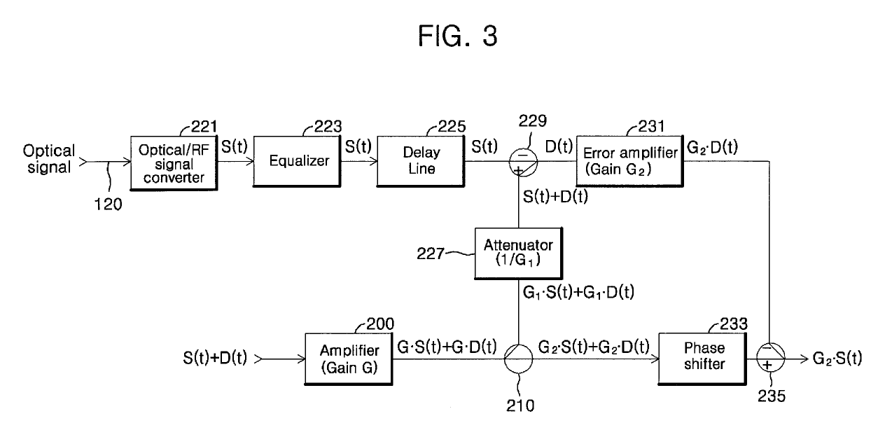

Each of the plural coaxial distribution hubs 112 comprises a distortion and noise canceling unit 122 according to the present invention and a two-way coaxial bridge amplifier 200 and 300 (shown only in FIG. 2, FIG. 3 and FIG. 4). The distortion and noise canceling unit 122 extracts the distortion and noise component contained in the RF signal using the degraded RF signal received through the coaxial cables 110 plus coaxial trunk amplifiers 114 and the undegraded optical signal received through the optical fiber 120. Then, the distortion and noise canceling unit 122 combines the extracted distortion and noise component with the degraded RF signal received through the coaxial cable 110 plus trunk amplifiers 114 and cancels out the distortion and noise component contained in the degraded RF signal.

FIG. 2 is a schematic diagram showing a preferred embodiment of the HFC network including a distortion and noise canceling system according to the present invention. Referring to FIG. 2, the RF signal received through the coaxial cable 110 is amplified by an amplifier 200 and inputted to a directional coupler 210, and a portion of the RF signal is split by the directional coupler. The split RF signal is inputted to a distortion and noise component extraction circuit 220 of the distortion and noise component canceling unit 122.

The distortion and noise component extraction circuit 220 comprises an optical/RF signal converter 221, an equalizer 223, a delay line 225, an attenuator 227 and a directional coupler 229. The optical signal received from the optical splitter 118 through the optical fiber 120 is inputted into the optical/RF signal converter 221 of the distortion and noise component extraction circuit 220 and converted into an RF signal. The RF signal converted by the optical/RF signal converter 221 is inputted to the equalizer 223, where the frequency response characteristic of the converted RF signal is adjusted to the same one as the frequency response characteristic of the RF signal received through the coaxial cables 110 and cascade coaxial amplifiers 114 and amplifier 200.

The RF signal equalized by the equalizer 223 is inputted to delay line 225, is delayed the same timing as is delayed by the RF signal passed through the coaxial path including all coaxial cables 110 and cascade amplifiers 114, etc., and then inputted to the negative polarity (−) input terminal of the directional coupler 229.

On the other hand, the degraded RF signal from the coaxial path outputted from the amplifier 200 is split by the directional coupler 210, and is inputted to an attenuator 227, where the RF signal level is adjusted to have the same level as the RF signal output from the delay line 225, and is inputted to the positive polarity (+) input terminal of the directional coupler 229.

Then, if the directional coupler 229 combines the undegraded RF signal from the delay line 225 and the degraded RF signal containing distortion and noise components from the attenuator 227, in opposite polarity, the pure signal (message) component included in both RF signals with reverse polarity is removed and the distortion plus noise (contamination) component included only in degraded RF signal is extracted as the difference of the two RF signals.

The distortion and noise component extracted by the directional coupler 229 is then inputted to an error amplifier 231 of a canceling circuit 230, amplified thereby, and input to the negative polarity (−) input terminal of a directional coupler 235. In addition, the main output of degraded RF signal from the directional coupler 210 is applied to a phase shifter 233, and the phase is adjusted to delay the same degree as is delayed by the error amplifier 231, and inputted to the positive polarity (+) input terminal of the directional coupler 235.

Therefore, the directional coupler 235 produces a clean RF signal in which the distortion and noise component is removed by combining the RF signal containing the distortion and noise component input into the straight polarity input terminal (+) from the phase shifter 233 with the distortion and noise component input into the reverse polarity input terminal (−) from the error amplifier 231.

Up to now, it was explained how the distortion and noise canceling system of the present invention removes the distortion and noise components from the degraded RF signal and finally produces a clean RF signal, qualitatively. However, it will be explained again here more definitely in a quantitative form using FIG. 3.

We assume that a pure RF signal component that does not have any distortion and noise is S(t) and a distortion and noise component mixed with the RF signal is D(t). Then, the RF signal with distortion and noise component S(t)+D(t), received through the coaxial cable 110 is applied to the input of amplifier 200. If we assume that the amplifier gain is G, the output signal of the amplifier 200 will be G·S(t)+G·D(t).

The output signal G·S(t)+G·D(t) of the amplifier 200 is split by the directional coupler 210 and the lesser level G₁·S(t)+G₁·D(t) are inputted to attenuator 227 and the greater level G₂·S(t)+G₂·D(t) are inputted to phase shifter 233. Here, if we set the attenuation value of the attenuator 227 to 1/G₁, the attenuator 227 attenuates the signal by 1/G₁ and outputs signal S(t)+D(t) and applies it to the positive input of directional coupler 229.

Meanwhile, the optical signal received through optical fiber 120 from optical splitter 118 is converted to RF signal in optical/RF signal converter 221 and suppose the level is set to the same level as S(t) above because the signal almost does not have any distortion and noise component. The converted RF signal S(t) converted by the optical/RF signal converter 221 is inputted to the negative polarity (−) input terminal of the directional coupler 229 through the equalizer 223 and the delay line 225.

Here, we neglect the insertion loss of both equalizer 223 and delay line 225 delays so that we suppose the level of RF signal S(t) in not changed through both devises.

The directional coupler 229 combines the RF signal S(t)+D(t) arrived at the positive (+) input terminal with the pure RF signal S(t) arrived at the negative (−) input terminal and extracts only distortion and noise component D(t) by canceling out the signal components S(t), as shown in the mathematical expression 1:

[S(t)+D(t)]−S(t)=D(t) (1)

The distortion and noise component D(t) extracted by the directional component 229 is now amplified by the error amplifier 231. Here, it is assumed that the gain of the error amplifier 231 is adjusted to G₂. Then, the output signal of the error amplifier 231 becomes G₂·D(t) and is inputted to the negative (−) input terminal of the directional coupler 235.

On the other hand, the RF signal G₂·S(t)+G₂·D(t) split by the directional coupler 210 is phase-shifted properly to be aligned with the phase RF signal G₂·D(t) output from the error amplifier 231, and is inputted to the positive (+) input terminal of the directional coupler 235.

Therefore, the directional coupler 235 combines the signal G₂·D(t) with the RF signal G₂·S(t)+G₂·D(t) and produces a clean RF signal G₂·S(t) that does not have any distortion and noise component, as shown in mathematical expression 2:

[G₂−S(t)+G₂·D(t)]−G₂·D(t)=G₂−S(t) (2)

FIG. 4 is a detailed schematic diagram showing an embodiment in which the distortion and noise canceling system of the present invention is applied to a bridge amplifier of a coaxial distribution hub in an HFC network. Here, reference numeral 300 is a schematic diagram of a typical commercial coaxial bridge amplifier normally used in conventional HFC networks, and comprises upstream(reverse or return) signal paths as well as downstream(forward) signal paths, an alternating current(AC) power supply connection, a transponder signal paths for status monitoring and control for network management system, and the like.

And the reference numeral 400 is actually a distortion and noise canceling unit which is designated as reference numeral 122 in FIGS. 1 and 2, and is an additional portion to the existing coaxial bridge amplifier 300 in a conventional HFC network to modify and upgrade the conventional HFC network according to the present invention. However, as an actual commercial product, a plug-in-delay, a plug-in-pad and the like should be added for the convenience of installation and adjustment, and minor configurations could be modified. For this portion, detailed operational descriptions were already given above in FIG. 2 and will be omitted here.

Each of reference numerals 302, 304, 306, 308 and 310 in the coaxial bridge amplifier 300 designates a coaxial cable connection terminal. The coaxial cable connection terminal 302 is an input terminal of a downstream RF signal (also works as an output terminal of a upstream RF signal) transmitted from the ONU 108 of the HFC network through the coaxial cable 110. The coaxial cable connection terminals 304, 306, 308 and 310 are bridge output terminals, and also act as input terminals of upstream signals from subscribers to ONUs for bi-directional communication. That is, the signal frequency spectrum is divided into a low frequency band and a high frequency band, and each band is allocated for upstream signals and downstream signals respectively.

The reference numeral 200 forms only a one-way (downstream) amplifier circuit which represents the same reference numeral 200 in FIG. 2 and FIG. 3. Reference numeral 312 designates an RF-AC inserter/separator, which is an LC impedance network for inserting or separating the AC power into or from the RF circuits. By using this, the coaxial cable works not only for the RF signal transmission line but also for the AC 50 to 60 Hz power supplying media without installing a separate AC power cable. The AC power is rectified and converted into direct current (DC) voltage by a rectifier (not shown) and is supplied to amplifiers and all other active circuits. Although the RF-AC inserter/separator 312 is shown only at the coaxial cable connection terminal 302, it is provided in all the coaxial cable connection terminals 304, 306, 308 and 310.

Reference numeral 314 designates a diplexer, which is a combination of a high pass filter (HPF) and a low pass filter (LPF) connected side by side. If signals of low band frequencies and high band frequencies are applied to the center inlet of the diplexer 314, the diplexer outputs the high band frequencies signal to an upper HPF portion (H) outlet and the low band frequencies signal to a lower LPF portion (L) outlet, and vice versa.

Therefore, if high frequencies RF (downstream) signal mixed with AC power is inputted to the coaxial cable connection terminal 302, the high frequencies RF signal is through the RF side of the RF-AC inserter/separator 312, supplied to the center inlet of the diplexer 314, and passed through the upper HPF portion (H), while the AC power is filtered and separated downward through the AC side of the RF-AC inserter/separator 312 and connected to a rectified power supply circuits (not shown). Instead, an external AC power supply such as battery banks or an uninterruptible power supply (UPS) can be connected to the AC side of the RF-AC inserter/separator 312 to provide AC power through connection terminal 302 to coaxial cable 110 outside.

The RF signal output from (H) portion of the diplexer 314 is inputted to an equalizer 316 which compensates the input RF signal flatness (or frequency response), and is also inputted to an attenuator pad 318, where the input RF signal level is adjusted to a proper level to drive a pre-amplifier 320.

The RF signal amplified by the pre-amplifier 320 passes through a band pass filter (BPF) and amplifier gain adjuster 322, where the forward transmission bandwidth and system gain is determined. The second attenuator pad 324 properly sets the RF signal drive level for the post-amplifier 330 and the second equalizer 326 determines the frequency response characteristic of downstream output signal. The downstream RF signal is now inputted to the post-amplifier 330 through a PIN diode 328 and amplified to the final amplitude level.

Here, the PIN diode 328 automatically controls the input level of the post-amplifier 330 to stabilize the output signal level to the branch network by the extraction and feedback of the amplitude level of a bridge network output amplifier 366. This negative feedback operation is performed by a directional coupler 332 picking up the bridge output downstream level, an attenuator pad 334, and an automatic level control (ALC) circuitry 336.

The output signal of the post-amplifier 330 is inputted to a “direct output“-”distortion/noise cancellation” mode switch 338. If the movable terminal of the mode switch 338 is connected to one fixed terminal ‘a’, the output signal of the post-amplifier 330 does not pass through the distortion and noise canceling unit 400 of the present invention and is directly inputted to a directional coupler 340. Contrary to that, if the movable terminal of the mode switch 338 is connected to another fixed terminal ‘b’, the output signal of the post-amplifier 330 is inputted to the distortion and noise canceling unit 400 of the present invention, and after processing thereof, the clean RF signal is consequently inputted to the directional coupler 340 after the distortion and noise component is canceled out.

The operation of the distortion and noise canceling unit 400 is the same as the operation of FIG. 2 above, and will be omitted here.

A small portion of the signal inputted to the directional coupler 340 is supplied to a transponder 342, and the received signals for network device control contained in the downstream signal are decoded for the network management system (NMS). Also, the status monitoring output signals from the transponder 342 is outputted to the coaxial cable connection terminal 302 via a directional coupler 344, an upstream amplifier 346, a band pass filter (BPF) and amplifier gain adjuster 348 determining the reverse transmission bandwidth and a reverse system gain, a upstream attenuator pad 350, a upstream equalizer 352, a low pass filter which is the (L) portion of the diplexer 314, and the RF-AC inserter/separator 312, Thus, controlling and responding signals of the transponder 342 are received and transmitted from and to head-end.

The major signal output of the directional coupler 340 passes through a bridge network equalizer 354 and a bridge attenuation pad 356, and is split into two signals at equal level by a RF splitter 358. One of the signals split by the RF splitter 358 is outputted to the coaxial cable connection terminals 304 and 306 after amplified by a bridge amplifier 360 and through a diplexer 362, and then transmitted to the following network elements and subscriber terminals.

The other signal split by the RF splitter 358 is outputted to the coaxial cable connection terminals 308 and 310 through a bridge attenuator pad 364, and after amplified by a bridge amplifier 366, through a directional coupler 332 and a diplexer 368, and then transmitted to the subscriber terminal side. The directional coupler 332 detects the reference level of the bridge output signal for ALC feedback operation as described above.

In addition, upstream RF signals inputted at the coaxial cable connection terminals 304, 306 and 308, 310 coming from the following network devices and/or subscriber terminals are gathered together in a RF combiner 374 via low pass filters of the diplexers 362 and 368, and upstream (or return) switches 370 and 372, and are combined into single upstream signal. The combined signal passes through the directional coupler 344, and is amplified by the upstream amplifier 346. Then, the amplified signal is outputted to the coaxial cable connection terminal 302 through a band pass filter (BPF) and amplifier gain adjuster 348, the upstream attenuation pad 350, the upstream equalizer 352, the low pass filter portion (L) of the diplexer 314, and the RF-AC inserter/separator 312, and finally transmitted toward the head-end. The upstream switches 370 and 372 pass signals if an upstream signal exists, and cut off the circuit to remove unnecessary upstream noises if the upstream signal is not used.

If the distortion and noise canceling system according to the present invention is employed in an HFC network, it reduces distortion and noise in the signal considerably. Some experiment and simulation showed the improvement of CNR, CSO and CTB at least more than 2 to 3 dB, 4 to 5 dB, and 10 dB, respectively. If we assume that the distance of a coaxial path in an existing HFC network is about 2 Km, the performance improvement enables a coaxial transmission distance to be lengthened by twice to three times, thereby extending the distance at least up to 4 to 6 Km. In this case, when the transmission distance is maintained the same as the existing distance, the transmission bandwidth or the number of transmission channels can be expanded almost twice (e.g., if the number of existing TV transmission channels is 60, the number of channels is increased to about 90 to 120) in accordance with the performance gain.

Accordingly, the distortion and noise canceling system according to the present invention can either be additionally equipped and modified into an existing HFC network already constructed, or be applied to a newly installed HFC network, so that the network transmission characteristic is highly improved and prominent signal performance and quality is realized. In conclusion, present invention upgrades and evolves a HFC network into the new generation one.

Meanwhile, although the present invention has been described and illustrated in connection with the specific preferred embodiments, it will be readily understood by those skilled in the art that various modifications can be made thereto without departing from the spirit and scope of the present invention.

Therefore, the scope of the present invention should not be limited to the aforementioned embodiments, but should be defined by the appended claims and equivalents thereto.

What is claimed:

1. A system for canceling distortions and noises in hybrid fiber-coax (HFC) networks, comprising:
an optical network unit for converting an optical signal received from a head-end side through a first optical fiber into an RF signal and transmitting the converted RF signal to a coaxial distribution hub through a coaxial path of a coaxial cable;
multiple coaxial trunk amplifiers connected to the coaxial cable in cascade to amplify the RF signal;
an optical tap-off or an optical coupler for tapping an optical signal from the first optical fiber and transmitting the tapped optical signal to the coaxial distribution hub through a second optical fiber; and
a distortion and noise canceling unit provided in the coaxial distribution hub, extracting a distortion and noise component contained in the RF signal received through the coaxial path using the optical signal transmitted through the second optical fiber, and canceling the distortion and noise component by combining the extracted distortion and noise component with the degraded RF signal received through the coaxial path.

2. The system of claim 1, wherein the distortion and noise canceling unit further comprising:
a distortion and noise component extraction circuit for converting the optical signal received through the second optical fiber into an undegraded RF signal and extracting the distortion and noise component by combining the converted RF signal with the degraded RF signal received through the coaxial path of the coaxial cables and cascaded coaxial amplifiers; and
a canceling circuit for canceling the distortion and noise component by combining the distortion and noise component extracted by the distortion and noise component extraction circuit with the degraded RF signal received through the coaxial path.

3. The system of claim 2, wherein the distortion and noise canceling unit further comprises a directional coupler for splitting the RF signal received through the coaxial path and respectively inputting the split RF signals into the distortion and noise component extraction circuit and the canceling circuit.

4. The system of claim 2, wherein the distortion and noise component extraction circuit further comprising:
an optical/RF signal converter for converting the optical signal received through the second optical fiber into the RF signal;
a delay line for delaying the RF signal converted by the optical/RF signal converter; and
a directional coupler for extracting the distortion and noise component by subtracting the RF signal delayed by the delay line from the degraded RF signal received through the coaxial path.

5. The system of claim 4, wherein the distortion and noise component extraction circuit further comprises an equalizer after the optical/RF signal converter or after the delay line to adjust the frequency response characteristic of the RF signal converted by the optical/RF signal converter.

6. The system of claim 4, wherein the distortion and noise component extraction circuit further comprises a RF attenuator for attenuating the RF signal received through the coaxial path.

7. The system of claim 2, wherein the canceling circuit comprises a directional coupler for subtracting the distortion and noise component extracted by the distortion and noise component extraction circuit from the RF signal received through the coaxial path.

8. The system of claim 7, wherein the canceling circuit further comprises:
an error amplifier for amplifying the distortion and noise component extracted by the distortion and noise component extraction circuit and inputting the amplified distortion and noise component into the directional coupler; and
a phase shifter for shifting the phase of the RF signal received through the coaxial path and inputting the shifted RF signal into the directional coupler.
